(19) United States
(12) Patent Application Publication
(10) Pub. No.: US 2009/0015592 A1
(43) Pub. Date: Jan. 15, 2009

(54) DISPLAY WITH EFFICIENT MEMORY USAGE

(75) Inventor: Archana S., Bangalore (IN)

Correspondence Address: DUANE MORRIS LLP (AGERE);IP DEPARTMENT, 30 SOUTH 17TH STREET, PHILADELPHIA, PA, 19103-4196, US

(73) Assignee: LSI CORPORATION, Milpitas, CA (US)

(21) Appl. No.: 11/776,345

(22) Filed: Jul. 11, 2007

(51) Int. Cl. G06F 3/048; G09G 5/00

(52) U.S. Cl. 345/581; 345/660; 715/784; 715/788; 715/800

(57) ABSTRACT

A device is capable of displaying an image. The device includes a memory having a first memory portion for receiving a set of image data. A display has a viewport for displaying the set of image data in an image that fits within and fills the viewport. A processor is programmed for executing computer program instructions for receiving a zoom factor selected by a user; applying a zoom transformation to a first subset of the image data corresponding to points in a first region of the image that are displayed within the viewport after magnifying the first region based on the zoom factor; and displaying the zoom transformed first subset of the image data so as to fill the viewport, while a second subset of the image data representing points outside the first region have not been transformed.

### FIELD OF THE INVENTION

The present invention relates to zoom functions for embedded displays.

### BACKGROUND

Imaging operations on embedded display platforms use relatively large portions of the available memory to carry out numerically intensive operations such as image zoom, panning, and scrolling.

On a handheld device, such as a cellular phone, the display screen has a portion which is available for displaying image data; this portion is referred to as the viewport. For example, in a typical camera phone, the display includes a viewport that displays the image, a header region with status information (e.g., image size in pixels), and a footer region with additional information (e.g., icons) and/or soft keys.

When the user wishes to zoom in on a portion of the image, a mathematical transformation is performed on all of the image data in the image, assigning new X-Y coordinate pairs to each point in the image. The transformed data point that fit within the viewport are displayed. The remaining data reside in the memory, but are not displayed unless the user performs a scanning or scrolling operation.

The image data transformation uses large amounts of memory and processing time.

### SUMMARY OF THE INVENTION

Some embodiments include a method for displaying an image. A set of image data are received for displaying an image that fits within and fills a viewport of a device. A zoom factor selected by a user is received. A zoom transformation is applied to a first subset of the image data corresponding to points in a first region of the image. The points in the first region of the image are displayed within the viewport of the device after magnifying the first region based on the zoom factor. The zoom transformed first subset of the image data are displayed so as to fill the viewport, while a second subset of the image data representing points outside the first region have not been transformed.

Some embodiments provide a device capable of displaying an image. The device includes a memory having a first memory portion for receiving a set of image data. A display has a viewport for displaying the set of image data in an image that fits within and fills the viewport. A processor is programmed for executing computer program instructions for receiving a zoom factor selected by a user; applying a zoom transformation to a first subset of the image data corresponding to points in a first region of the image that are displayed within the viewport after magnifying the first region based on the zoom factor; and displaying the zoom transformed first subset of the image data so as to fill the viewport, while a second subset of the image data representing points outside the first region have not been transformed.

### BRIEF DESCRIPTION OF THE DRAWINGS

FIG. 1A is a diagram of an exemplary cellular phone according to one embodiment.

FIG. 1B is a diagram of the memory of FIG. 1A.

FIG. 2 is a flow chart of a method for managing the memory in the cellular phone of FIG. 1.

FIG. 3 is a flow chart for panning or scrolling an image that has been zoomed according to the method of FIG. 2.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

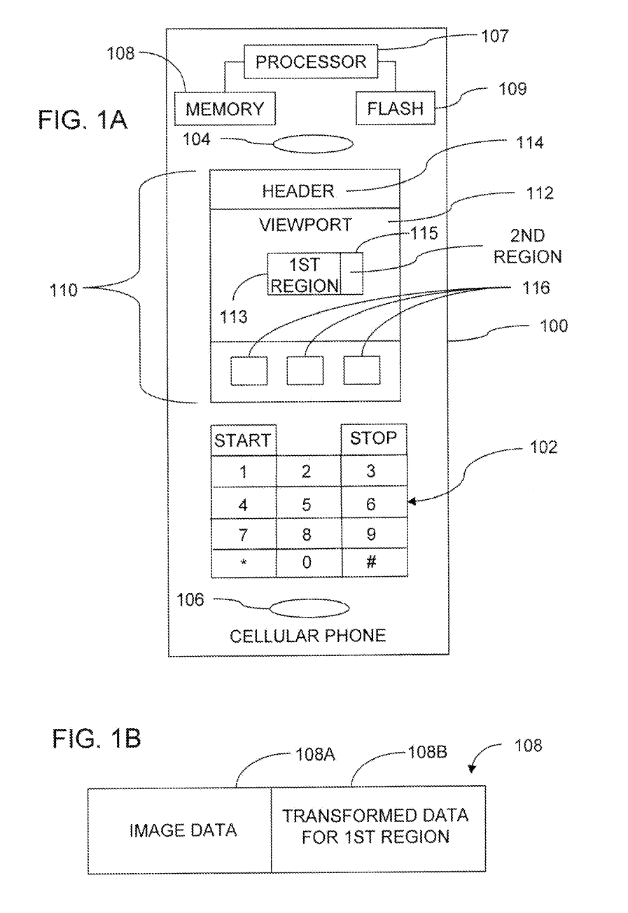

FIG. 1A shows a device 100 capable of displaying an image. Although the example of a device 100 in the embodiment of FIG. 1A is a cellular phone, in other embodiments, the device may be another portable device capable of displaying an image, such as, but not limited to: a personal digital assistant, a camera, a camcorder, a television or other handheld consumer device.

The device 100 includes a number of features, such as a keypad 102, a speaker 104, and a microphone 106, the functions of which are understood by those of ordinary skill in the art.

The display 110 includes a viewport 112 for displaying a set of image data in an image that fits within and fills the viewport. The display 110 further comprises a status region 114 and a plurality of soft buttons 116.

The device 100 includes a programmed processor 107. In some embodiments, the programmed processor 109 is a digital signal processor implemented in application specific integrated circuits (ASIC). In other embodiments, the processor 107 is a general purpose microprocessor that executes instructions stored in an instruction memory, such as a flash memory 109, a read-only-memory (ROM), or the like. An electrically erasable memory, such as flash memory 109 allows simple installation of updates to the device firmware.

A memory 108 has a first memory portion 108A (FIG. 1B) for receiving a set of image data, and a second memory portion 108B for storing transformed data for a first region 113 of the image. The second portion of the memory may also include a workspace used by the processor 107 during the image data transformation operation.

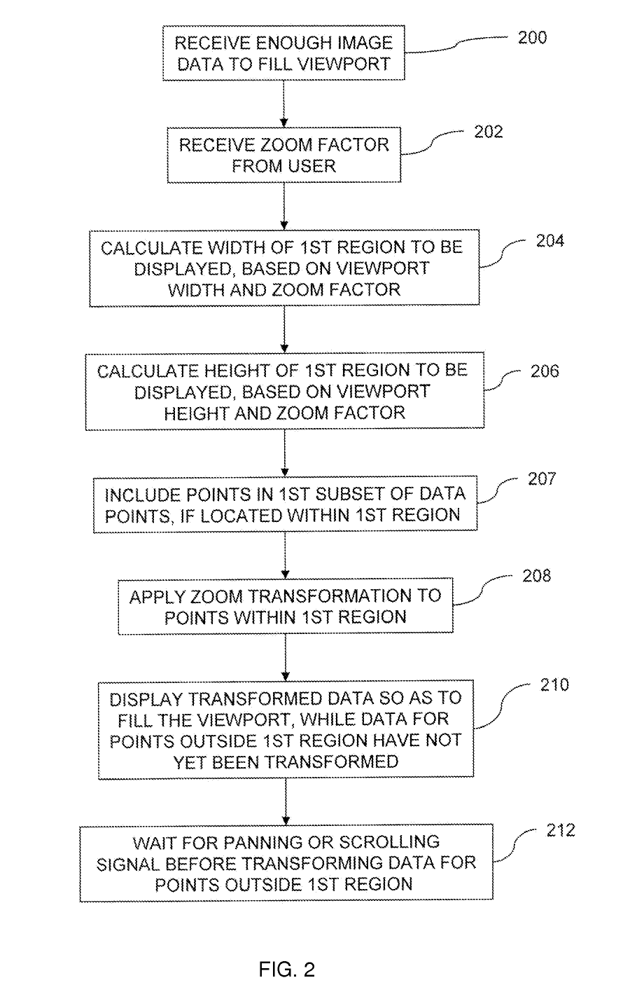

FIG. 2 is a flow chart showing an exemplary method for performing a zoom operation in the device 100 of FIG. 1A.

At step 200, the device 100 receives enough image data to fill the viewport 112. For example, in a camera phone embodiment, a new image may be collected using the phone's built-in image sensor (not shown), or a previously stored image may be loaded from a non-volatile memory device (not shown), such as a flash memory, or downloaded via the Internet.

At step 202, the processor 107 receives a zoom factor selected by a user. The zoom factor represents the amount of magnification to be applied to the portion of the image displayed in the viewport 112. The specific application program being executed determines how the user is queried for the zoom factor. In one example, the user viewing an image on a camera phone 100 selects a “zoom” soft key 116. The display may provide a list of entries corresponding to a plurality of zoom factors, from which the user can scroll up or down and select a value. Alternatively, the user can select one of the zoom values by pressing one of the numbered keys on keypad 102.

At step 204, a width of the first region 113 is calculated based on a width of the viewport and the zoom factor. The width of the first region 113 (in millimeters or in pixels) equals the width of the viewport 112 (in millimeters or in pixels) divided by the zoom factor. The width of the viewport is particular to each platform, and can be retrieved with a call to the application program interface (API).

At step 206, a height of the first region 113 is calculated based on a height of the viewport 112 and the zoom factor. The height of the first region 113 (in millimeters or in pixels) equals the height of the viewport 112 (in millimeters or in pixels) divided by the zoom factor.

At step 207, data points are included in a first subset of the image data, representing points that lie within the first region 113 based on the calculated width and height of the first region 113. The points to be included can be determined by calculating the minimum and maximum X and Y values of the corners of the 1^{st} region, based on the width and height calculated in steps 204 and 206, and the location of the center of the 1^{st} region (which coincides with the center of the image before any zooming or panning occurs). Each point in the set of image data having an X value between than the minimum X and the maximum X values, and a Y value between the minimum Y and the maximum Y values is included in the first subset.

At step 208, a zoom transformation is applied to the first subset of the image data corresponding to points in the first region of the image that are displayed within the viewport 112 after magnifying the first region based on the zoom factor. The zoom transformation maps each point in the first region 113 to a new point in a rectangle that fills the viewport 112. The zoom transformation includes a scalar multiplication and an offset:

X_{TRANSFORMED}=X_{CENTER}+Zoom Factor*(X_{ORIGINAL}−X_{CENTER})

Y_{TRANSFORMED}=Y_{CENTER}+Zoom Factor*(Y_{ORIGINAL}−Y_{CENTER})

where X_{TRANSFORMED} and Y_{TRANSFORMED} are the transformed values of X and Y; X_{CENTER} and Y_{CENTER} are the location of the center of the image in the coordinate system in use (which may be referenced from the center point, or any of the corner points of the viewport; and X_{ORIGINAL} and Y_{ORIGINAL} are the locations of the point relative to the center of the image, prior to the transformation.

At step 210, the zoom transformed first subset of the image data are displayed so as to fill the viewport 112, while a second subset of the image data representing points outside the first region 113 have not yet been transformed. By displaying the zoomed points immediately after the locations of the points in the ₁st region are mapped to new locations in the viewport 112, the use of the second memory portion 108B for storing transformed data is minimized, and the time to perform all of the data point transformations is also minimized. For example, if a zoom factor of four is chosen, then the locations of only one fourth of the transformed data points are calculated before displaying the magnified image, cutting the use of memory portion 108B by a factor of four, and reducing the processor calculation time for the zoom transformation by about a factor of four. Thus, the second memory portion 108B sized for storing the zoom transformed first subset of the image data can be substantially smaller than the first memory portion 108A, which accommodates all of the data points for the full unmagnified image. The amount of memory space that can be saved depends on the lowest magnification available to the user. For example, if the lowest magnification for zooming is two times, then the second memory portion 108B can be about half as large as memory portion 108A.

At step 212, the processor 107 waits until a panning signal or a scrolling signal is received before applying the zoom transformation to any of the second subset of the image data (where the second subset includes data corresponding to the remaining points of the full image outside of the first region 113. The panning or scrolling signal may be input by the user, using controls such as soft keys 116. For example, the processor 107 may be programmed to only transform points that are to be displayed in the panned or scrolled image. Then the processor 107 would only perform the zoom transformation calculations for the points that are actually displayed after the zooming, panning or scrolling step is performed.

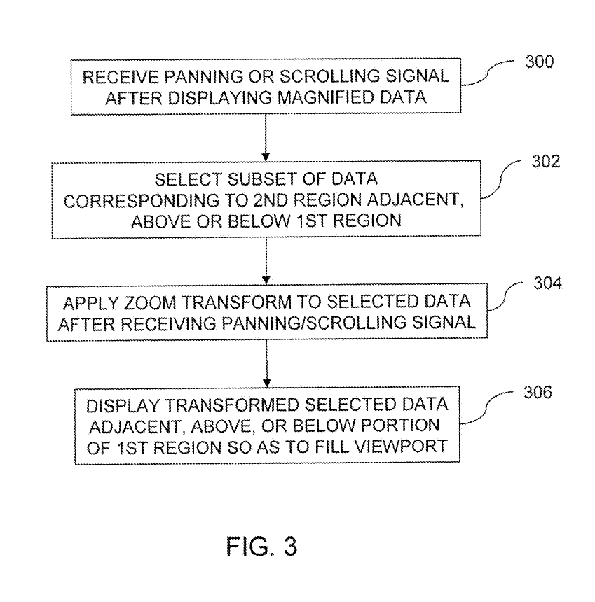

FIG. 3 shows a panning or scrolling operation. Although panning and scrolling can be performed independently of each other, and can be performed sequentially, the logic and mathematics of a scrolling operation are similar to that involved in panning, so it is conceptually desirable to discuss the two together.

At step 300, the processor receives the panning or scrolling signal input by the user, after the magnified data are initially displayed in a zoom image in step 210.

At step 302, in response to the panning or scrolling signal, the processor selects a third subset of the image data corresponding to a second region 115 of the image adjacent to, above, or below the first region 113 of the image. In some embodiments, the panning or scrolling operation causes a predetermined percentage of the points currently displayed in the image to be added on one side and the same percentage of the points in the image to be deleted from the opposite side of the image, with the remaining points in between all shifted away from the added points of the second region 115.

Alternatively, the panning or scrolling operation may cause a predetermined number of the points in the image to be added on one side and the same percentage of the points in the image to be deleted from the opposite side of the image, with the remaining points in between all shifted away from the added points of the second region 115. That is, if the adjacent second region 115 is added on the right as shown in FIG. 1A, then the points corresponding to the right edge of the 1^{st} region 113 before the panning operation are shifted to the left by a distance corresponding to the width of the second region 115.

At step 304, the processor applies the zoom transformation to the third subset of the image data (in the second region 115) after receiving the panning or scrolling signal.

At step 306, the display 110 displays the zoom transformed third subset of the image data in the second region 115 adjacent to a sufficient portion of the zoom transformed first subset of the image data so as to fill the viewport 112.

Although specific examples are described above, in any sequence including one or more zoom, pan and/or scroll operations, the memory usage can be optimized by only transforming image data corresponding to points that are to be viewed upon completion of each zoom, pan and/or scroll operation. Points that are not to be viewed upon completion of each zoom, pan and/or scroll operation are not transformed at the time that operation is performed. Thus, the only part of the original source image that is transformed during a zoom, pan or scroll operation is that part which, when zoomed by a given ratio, or panned or scrolled by a given amount, fits within the display screen's viewport.

For example, one possible sequence includes zooming in by a relatively large zoom magnification factor (e.g., 10), panning by 30% of the width of the image, scrolling by 20% of the height of the image, and zooming out to a relatively small zoom magnification factor (e.g., 4). Each of the four operations involves transforming additional data that either have not been previously transformed, or if they have been previously transformed, were not mapped to the specific locations within the viewport that they will occupy after the current transformation.

The exemplary embodiments of present invention may be embodied in the form of computer-implemented processes and apparatus for practicing those processes. Other embodiments are in the form of computer program code embodied in tangible computer readable storage media, such as random access memory (RAM), floppy diskettes, read only memories (ROMs), CD-ROMs, DVD-ROMs, hard drives, flash drives, or any other computer-readable storage medium, wherein, when the computer program code is loaded into and executed by a computer, the computer becomes an apparatus for practicing the invention. Other embodiments are in the form of computer program code, loaded into and/or executed by a computer, wherein when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for displaying an image, comprising:
receiving a set of image data for displaying an image that fits within and fills a viewport of a device;
receiving a zoom factor selected by a user;
applying a zoom transformation to a first subset of the image data corresponding to points in a first region of the image that are displayed within the viewport of the device after magnifying the first region based on the zoom factor,
displaying the zoom transformed first subset of the image data so as to fill the viewport, while a second subset of the image data representing points outside the first region have not been transformed.

2. The method of claim 1, further comprising waiting until a panning signal or a scrolling signal is received before applying the zoom transformation to any of the second subset of the image data.

3. The method of claim 2, further comprising:
receiving the panning signal after displaying the magnified data;
selecting a third subset of the image data corresponding to a second region of the image adjacent to the first region of the image in response to the panning signal;
applying the zoom transformation to the third subset of the image data after receiving the panning signal;
displaying the zoom transformed third subset of the image data adjacent to a sufficient portion of the zoom transformed first subset of the image data so as to fill the viewport.

4. The method of claim 2, further comprising:
receiving the scrolling signal after displaying the magnified data;
selecting a third subset of the image data corresponding to a second region of the image above or below the first region of the image in response to the scrolling signal;
applying the zoom transformation to the third subset of the image data after receiving the scrolling signal;
displaying the zoom transformed third subset of the image data adjacent to a sufficient portion of the zoom transformed first subset of the image data so as to fill the viewport.

5. The method of claim 1, further comprising:
calculating a width of the first region based on a width of the viewport and the zoom factor;
calculating a height of the first region based on a height of the viewport and the zoom factor; and
including in the first subset image data representing points that lie within the first region based on the calculated width and height of the first region.

6. The method of claim 5, wherein the calculated width is determined by dividing the width of the viewport by the zoom factor, and the calculated height is determined by dividing the height of the viewport by the zoom factor.

7. The method of claim 1, wherein the display is included in a handheld consumer device.

8. The method of claim 1, wherein the zoom transformation is not applied to any data representing points outside the first region until a panning signal or a scrolling signal is received.

9. The method of claim 1, wherein the viewport has a size determined by a size of a display of the device, reduced by regions corresponding to at least one of the group consisting of an icon bar and a soft key.

10. A device capable of displaying an image, comprising:
a memory having a first memory portion for receiving a set of image data a display having a viewport for displaying the set of image data in an image that fits within and fills the viewport; and
a processor programmed for executing computer program instructions for:
receiving a zoom factor selected by a user;
applying a zoom transformation to a first subset of the image data corresponding to points in a first region of the image that are displayed within the viewport after magnifying the first region based on the zoom factor,
displaying the zoom transformed first subset of the image data so as to fill the viewport, while a second subset of the image data representing points outside the first region have not been transformed.

11. The device of claim 10, wherein the memory has a second memory portion sized for storing the zoom transformed first subset of the image data, the second memory portion being substantially smaller than the first memory portion.

12. The device of claim 10, wherein the processor is further programmed with instructions for waiting until a panning signal or a scrolling signal is received before applying the zoom transformation to any of the second subset of the image data.

13. The device of claim 12, further comprising:
a user control for providing the panning signal to the processor for selecting a third subset of the image data corresponding to a second region of the image adjacent to the first region of the image in response to the panning signal;
wherein the processor is further programmed with instructions for applying the zoom transformation to the third subset of the image data after receiving the panning signal, and
the display displays the zoom transformed third subset of the image data adjacent to a sufficient portion of the zoom transformed first subset of the image data so as to fill the viewport.

14. The device of claim 10, wherein the display is included in a handheld consumer device.

15. The device of claim 14, wherein the handheld consumer device is one of the group consisting of a telephone, a personal digital assistant, a camera, a camcorder, and a television.

16. The device of claim 10, wherein the viewport has a size determined by a size of a display of the device, reduced by regions corresponding to at least one of the group consisting of an icon bar and a soft key.

17. A computer readable storage medium encoded with computer program code, such that, when the computer program code is executed by a processor, the processor performs a method for displaying an image, comprising:
receiving a set of image data for displaying an image that fits within and fills a viewport of a device;
receiving a zoom factor selected by a user;
applying a zoom transformation to a first subset of the image data corresponding to points in a first region of the image that are displayed within the viewport of the device after magnifying the first region based on the zoom factor,
displaying the zoom transformed first subset of the image data so as to fill the viewport, while a second subset of the image data representing points outside the first region have not been transformed.

18. The computer readable storage medium of claim 17, wherein the method further comprises waiting until a panning signal or a scrolling signal is received before applying the zoom transformation to any of the second subset of the image data.

19. The computer readable storage medium of claim 18, further comprising:
receiving the panning signal after displaying the magnified data;
selecting a third subset of the image data corresponding to a second region of the image adjacent to the first region of the image in response to the panning signal;
applying the zoom transformation to the third subset of the image data after receiving the panning signal;
displaying the zoom transformed third subset of the image data adjacent to a sufficient portion of the zoom transformed first subset of the image data so as to fill the viewport.

20. The computer readable storage medium of claim 18, further comprising:
receiving the scrolling signal after displaying the magnified data;
selecting a third subset of the image data corresponding to a second region of the image above or below the first region of the image in response to the scrolling signal; scrolling signal;
displaying the zoom transformed third subset of the image data adjacent to a sufficient portion of the zoom transformed first subset of the image data so as to fill the viewport.

21. The computer readable storage medium of claim 17, further comprising:
calculating a width of the first region based on a width of the viewport and the zoom factor;
calculating a height of the first region based on a height of the viewport and the zoom factor; and
including in the first subset image data representing points that lie within the first region based on the calculated width and height of the first region.

22. The computer readable storage medium of claim 21, wherein the calculated width is determined by dividing the width of the viewport by the zoom factor, and the calculated height is determined by dividing the height of the viewport by the zoom factor.

23. The computer readable storage medium of claim 17, wherein the computer readable storage medium is included in a handheld consumer device.

24. The computer readable storage medium of claim 17, wherein the zoom transformation is not applied to any data representing points outside the first region until a panning signal or a scrolling signal is received.

25. The computer readable storage medium of claim 17, wherein the viewport has a size determined by a size of a display of the device, reduced by regions corresponding to at least one of the group consisting of an icon bar and a soft key.
